(19) United States
(12) Patent Application Publication
(10) Pub. No.: US 2014/0334348 A1
(43) Pub. Date: Nov. 13, 2014

(54) FILTER CIRCUIT, INTEGRATED CIRCUIT, COMMUNICATION MODULE, AND COMMUNICATION APPARATUS

(71) Applicant: Sony Corporation, Tokyo (JP)

(72) Inventor: Sachio Iida, Chiba (JP)

(73) Assignee: Sony Corporation, Tokyo (JP)

(21) Appl. No.: 14/265,538

(22) Filed: Apr. 30, 2014

(30) Foreign Application Priority Data
May 7, 2013 (JP) 2013-097636

(51) Int. Cl. H04L 5/14

(52) U.S. Cl. CPC H04L 5/1461
USPC 370/278

(57) ABSTRACT

There is provided a filter circuit including one or more first capacitors which accumulate and emit a charge at a predetermined timing, one or more first amplifiers which are provided from an input terminal side to the one or more first capacitors and output a current proportional to an input voltage into the input terminal, and one or more second amplifiers which are provided from an output terminal side to the one or more first capacitors and output a current proportional to an output voltage from the output terminal. A proportionality coefficient of each of the one or more first amplifiers and each of the one or more second amplifiers is arbitrarily set.

### CROSS REFERENCE TO RELATED APPLICATIONS

This application claims the benefit of Japanese Priority Patent Application JP 2013-097636 filed May 7, 2013, the entire contents of which are incorporated herein by reference.

### BACKGROUND

The present disclosure relates to a filter circuit, an integrated circuit, a communication module, and a communication apparatus.

The spread of high performance wireless communication terminals typified by smart phones and the achievement of broadband of mobile communication through a high-speed wireless communication system, such as LTE (Long Term Evolution)-Advanced, have progressed. Then, effective use of frequency resources by a cognitive wireless technology applicable to various wireless communication systems in a wide range of frequencies has been expected. A discrete time charge domain filter applied to such wireless communication systems is disclosed in, for example, M. Tohidian, I. Madadi, and R. B. Staszewski, “A 2 mW 800 MS/s 7th-order discrete-time IIR filter with 400 kHz-30 MHz BW and 100 dB stop-band rejection in 65 nm CMOS,” Proc. of IEEE Solid-State Circuits Conf., sec. 10.2, 19 Feb. 2013 (Non-Patent Literature 1).

### SUMMARY

In view of the above-described circumstances, a filter circuit has been demanded which attenuates interfering waves of adjacent frequencies without affecting the circuit area of a communication terminal and without attenuating signals of a zone desired by the communication terminal.

According to the present disclosure, there are provided a filter circuit, an integrated circuit, and a communication apparatus which are novel and improved capable of attenuating interfering waves of adjacent frequencies without affecting the circuit area and without attenuating signals of a desired zone.

According to an embodiment of the present disclosure, there is provided a filter circuit, including one or more first capacitors which accumulate and emit a charge at a predetermined timing, one or more first amplifiers which are provided from an input terminal side to the one or more first capacitors and output a current proportional to an input voltage into the input terminal, and one or more second amplifiers which are provided from an output terminal side to the one or more first capacitors and output a current proportional to an output voltage from the output terminal. A proportionality coefficient of each of the one or more first amplifiers and each of the one or more second amplifiers is arbitrarily set.

According to an embodiment of the present disclosure, there is provided an integrated circuit, including the filter circuit.

According to an embodiment of the present disclosure, there is provided a communication module, including the integrated circuit and a duplexer.

According to an embodiment of the present disclosure, there is provided a communication apparatus, including the communication module, and an antenna which transmits and receives a radio wave and exchanges the radio wave with the communication module.

As described above, according to the present disclosure, a filter circuit, an integrated circuit, a communication module, and a communication apparatus which are novel and improved capable of attenuating interfering waves of adjacent frequencies without affecting the circuit area and without attenuating signals of a desired zone can be provided.

### BRIEF DESCRIPTION OF THE DRAWINGS

FIG. 1 is an explanatory view illustrating an example of the functional configuration of a wireless communication terminal capable of employing a high-speed wireless communication system;

FIG. 2 is an explanatory view illustrating an example of the configuration of a discrete time charge domain filter;

FIG. 3 is an explanatory view illustrating the waveforms of pulses for turning ON/OFF switches illustrated in FIG. 2;

FIG. 4 is an explanatory view illustrating an example of the configuration of a discrete time charge domain filter;

FIG. 5 is an explanatory view illustrating a discrete time charge domain 60 illustrated in Non-Patent Literature 1;

FIG. 6 is an explanatory view illustrating the waveforms of pulses applied to the discrete time charge domain 60 illustrated in FIG. 5;

FIG. 7 is an explanatory view illustrating an example of the frequency characteristic of the discrete time charge domain filter 60 illustrated in FIG. 5;

FIG. 8 is an explanatory view illustrating an example of the circuit configuration of a discrete time charge domain filter 100 according to one embodiment of the present disclosure;

FIG. 9 is an explanatory view showing the frequency characteristic of the discrete time charge domain filter 100 in a graph: and

FIG. 10 is an explanatory view showing the frequency characteristic of the discrete time charge domain filter 100 in a graph.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description is given in the following order;

1. One embodiment of present disclosure;

### Outline;

Example of circuit configuration; and

### 2. Conclusion.

### 1. ONE EMBODIMENT OF PRESENT DISCLOSURE

### Outline

First, the outline until one embodiment of the present disclosure is achieved is described before describing one embodiment of the present disclosure in detail.

As described above, the spread of high performance wireless communication terminals typified by smart phones and the achievement of broadband of mobile communication through a high-speed wireless communication system, such as LTE (Long Term Evolution)-Advanced, have progressed. The frequency band usable in mobile communication is limited. Therefore, with such a progress of the spread of high performance wireless communication terminals and the achievement of broadband of mobile communication, an increase in wireless communication traffic and exhaustion of frequency resources have posed problems.

Since the frequency bands assigned to the existing wireless communication systems are already widely present in the frequency range suitable for mobile communication, it is very difficult to secure a frequency band of a new wireless communication system in a wide band. Therefore, effective use of frequency resources by a cognitive wireless technology applicable to various wireless communication systems in a wide range of frequencies has been expected.

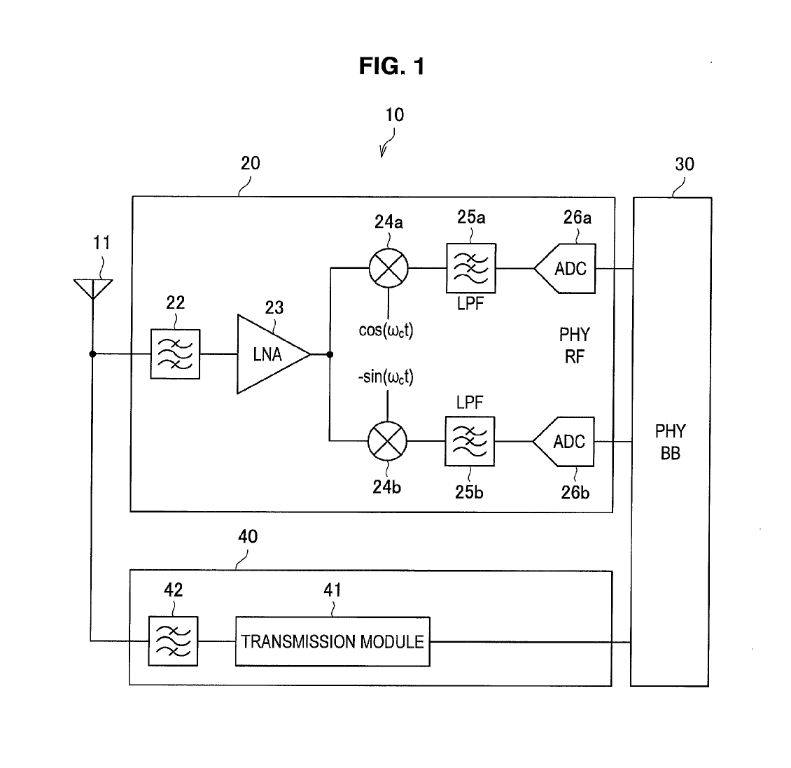

FIG. 1 is an explanatory view illustrating an example of the functional configuration of a wireless communication terminal capable of employing a high-speed wireless communication system, such as LTE-Advanced. A wireless communication terminal 10 illustrated in FIG. 1 includes an antenna 11, a receiving portion 20, a baseband treatment portion 30, and a transmission portion 40.

The receiving portion 20 treats radio waves transmitted from another device (for example, a base station, a base phone of wireless LAN, and the like) and received by the antenna 11, and then transmits the treated radio waves to a baseband treatment portion 30. The receiving portion 20 includes a duplexer 22, a LNA (Low Noise Amplifier) 23, mixers 24a and 24b, LPFs 25a and 25b, and A/D converters (ADC) 26a and 26b.

The radio waves received by the antenna 11 are prevented from being mixed with the transmission waves to be transmitted from the antenna 11 due to passing through the duplexer 22, and then amplified by the LNA 23. The radio waves amplified by the LNA 23 are mixed with a cosine wave and a sine wave by the mixers 24a and 24b, respectively, and then allowed to pass through predetermined frequency components in the LPFs 25a and 25b. Signals passing through the LPFs 25a and 25b are converted to digital signals by the AD converters 26a and 26b, respectively, and then transmitted to the baseband treatment portion 30.

The transmission portion 40 performs signal treatment for transmitting the signals from the baseband treatment portion 30 from the antenna 11. The transmission portion 40 includes a transmission module 41 which performs conversion from a digital signal to an analog signal or performs filter treatment and a duplexer 42 which prevents mixture with the radio waves received by the antenna 11.

The LPFs 25a and 25b are low pass filters for channel selection. The LPFs 25a and 25b to be used as the low pass filters for channel selection are demanded to have a tunable cutoff frequency, have a steep cutoff characteristic and a high linearity in order to reduce the interference from adjacent frequencies, and achieve low noise and low power consumption so that the LPFs 25a and 25b are applicable to various wireless communication systems.

It is demanded to realize such a high performance low pass filter for channel selection by a low-cost CMOS (Complementary Metal Oxide Semiconductor) process. With respect to the CMOS process, since miniaturization proceeds based on Moore's law and the power supply voltage decreases, it becomes gradually difficult to continue the realization of a filter circuit employing a former analog circuit design technique.

On the other hand, due to the miniaturization of the CMOS process, the transformer conductance coefficient of a transistor becomes high, a digital circuit and a switch circuit operates at high speed, and the capacity density of a capacitor also increases. Therefore, a switched capacitor filter can be operated at a high speed clock of a GHz order which has not been able to be imagined heretofore, and discrete time analog signal treatment can be performed. A discrete time charge domain filter which does not employ an operational amplifier achieves low noise and excellent linearity and can be subjected to scaling based on the Moore's law, and therefore has been actively researched and developed.

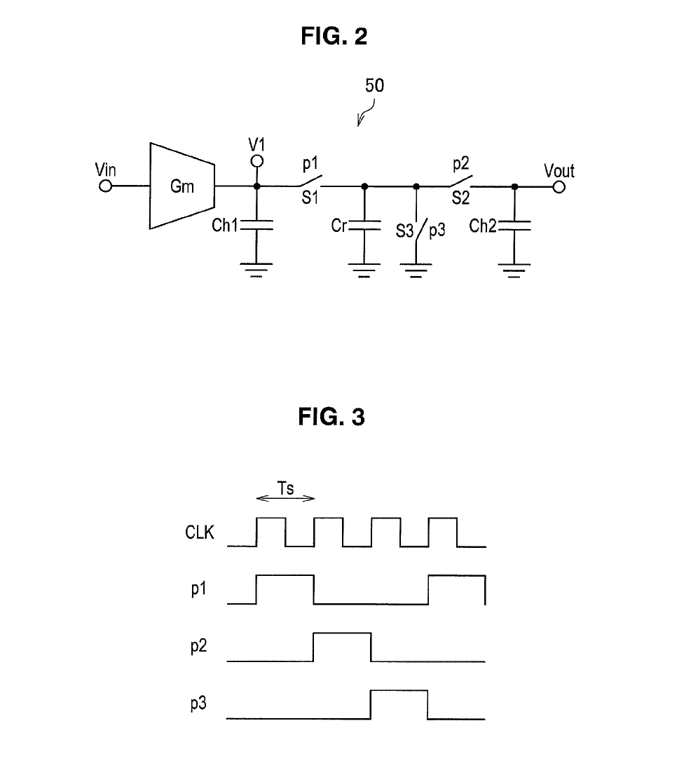

FIG. 2 is an explanatory view illustrating an example of the configuration of the discrete time charge domain filter. A discrete time charge domain filter 50 illustrated in FIG. 2 includes a transconductance amplifier Gm, history capacitors Ch1 and Ch2, a rotation capacitor Cr, and switches S1, S2 and S3.

The transconductance amplifier Gm is an amplifier which converts an input voltage to a current, and then outputs the current. The history capacitors Ch1 and Ch2 are capacitors which accumulate or emit charges at a predetermined timing. The timing at which the history capacitors Ch1 and Ch2 accumulate or emit charges is determined by the ON/OFF timing of the switches S1, S2, and S3. The rotation capacitor Cr is a capacitor which receives and accumulates charges accumulated in the history capacitor Ch1 or supplies the accumulated charges to the history capacitor Ch2 at a predetermined timing. V1 in the discrete time charge domain filter 50 illustrated in FIG. 2 indicates a first output voltage.

FIG. 3 is an explanatory view illustrating the waveforms of pulses for tuning ON/OFF the switches S1, S2, and S3 of the discrete time charge domain filter 50 illustrated in FIG. 2.

The transconductance amplifier Gm is a transconductance amplifier which outputs a current proportional to a voltage to be applied to an input terminal Vin of the discrete time charge domain filter 50. The current output from the transconductance amplifier Gm outputs is accumulated as a charge in the history capacitor Ch1.

The operation of the discrete time charge domain filter 50 illustrated in FIG. 2 is described. The switches S1, S2, and S3 are switches which enter the ON state when the pulses p1, p2, and p3 illustrated in FIG. 3 are high and enters the OFF state when the pulses are low. The pulses p1, p2, and p3 are pulses whose timing of becoming high shifts corresponding to one period (Ts) of a sampling clock CLK as illustrated in FIG. 3 and which are not overlapped with each other.

When only the pulse p1 becomes high, the switch S1 enters the ON state and the switches S2 and S3 enter the OFF state. When only the switch S1 enters the ON state, the charges accumulated in the history capacitor Ch1 are distributed to the rotation capacitor Cr.

When only the pulse p2 becomes high, the switch S2 enters the ON state and the switch S1 and S3 enter the OFF state. When only the switch S2 enters the ON state, the rotation capacitor Cr is connected to the history capacitor Ch2. When the rotation capacitor Cr is connected to the history capacitor Ch2, the charges accumulated in the rotation capacitor Cr are distributed to the history capacitor Ch2. The charges accumulated in the history capacitor Ch2 are output from an output Vout of the discrete time charge domain filter 50.

When only the pulse p3 becomes high, the switch S3 enters the ON state and the switch S1 and S2 enter the OFF state. When only the switch S3 enters the ON state, the rotation capacitor Cr is grounded. Therefore, the charges accumulated in the rotation capacitor Cr are discharged. Charges are accumulated in each of the history capacitor Ch1 and Ch2 of the discrete time charge domain filter 50 illustrated in FIG. 2, and therefore the discrete time charge domain filter 50 functions as an integrator.

A series of operations of the discrete time charge domain filter 50 by each stage of these pulses p1, p2, and p3 are repeated corresponding to three periods Ts of the sampling clock CLK. Then, by placing the discrete time charge domain filter 50 illustrated in FIG. 2 in parallel, the operation can be continuously performed for each period Ts of the sampling clock CLK.

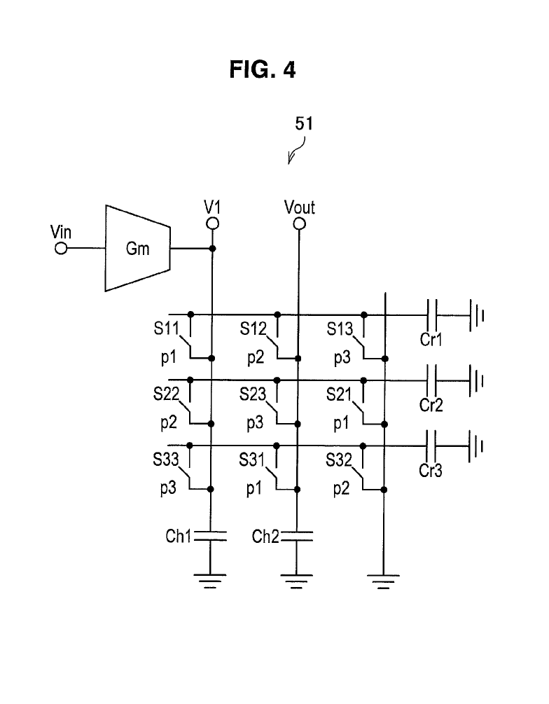

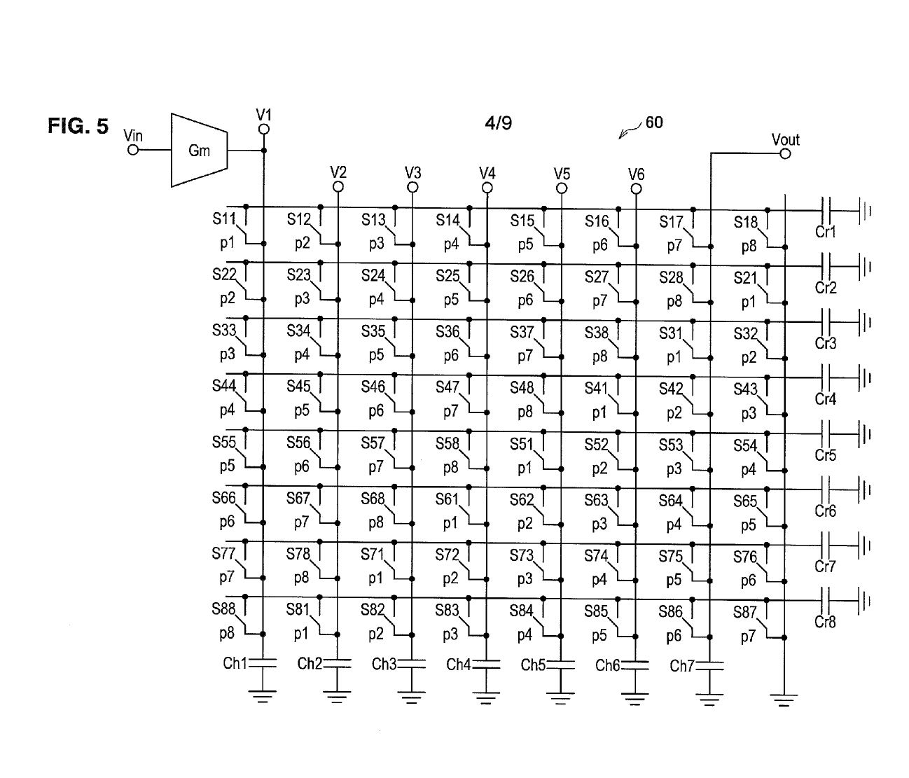

FIG. 4 is an explanatory view illustrating an example of the configuration of a discrete time charge domain filter. The discrete time charge domain filter 51 illustrated in FIG. 4 is a charge domain filter in which three pieces of the discrete time charge domain filter 50 illustrated in FIG. 2 are placed in parallel.

The discrete time charge domain filter 51 illustrated in FIG. 4 includes a transconductance amplifier Gm, history capacitors Ch1 and Ch2, the rotation capacitors Cr1, Cr2, and Cr3, and switches S11, S12, S13, S21, S22, S23, S31, S32, and S33. The p1, p2, and p3 attached to the vicinity of the switches S11, S12, S13, S21, S22, S23, S31, S32, and S33 indicate that each of the pulses p1, p2, and p3 illustrated in FIG. 3 is applied to the corresponding switch. More specifically, the switches S11, S12, S13, S21, S22, S23, S31, S32, and S33 are switches which enter the ON state when the pulses p1, p2, and p3 illustrated in FIG. 3 are high and which enter the OFF state when the pulses are low.

The discrete time charge domain filter 51 illustrated in FIG. 4 is configured so that the history capacitors Ch1 and Ch2 have the same capacity and the rotation capacitors Cr1, Cr2, and Cr3 have the same capacity. V1 in the discrete time charge domain filter 51 illustrated in FIG. 4 indicates a first output voltage.

The discrete time transfer function of the discrete time charge domain filter 51 illustrated in FIG. 4 is represented by Expression 1. In Expression 1, Gm denotes the transconductance coefficient of the transconductance amplifier Gm, Ts denotes the period of the sampling clock, Cr denotes the capacity of the rotation capacitors Cr1, Cr2, and Cr3, and Ch denotes the capacity of the history capacitors Ch1 and Ch2.

$$H ( z ) = \frac{{{GmT}_{S} ( {C}_{r} {z}^{- 1} )}^{1}}{{( {C}_{h} ( 1 - {z}^{- 1} ) + {C}_{r} )}^{2}} \qquad ( Expression 1 )$$

As described above, the research of the discrete time charge domain filter which is applied to wireless communication systems and which does not employ an operational amplifier has been advanced. For example, Non-Patent Literature 1 discloses the realization of a 7th-order IIR low pass filter with a discrete time charge domain filter which does not employ an operational amplifier.

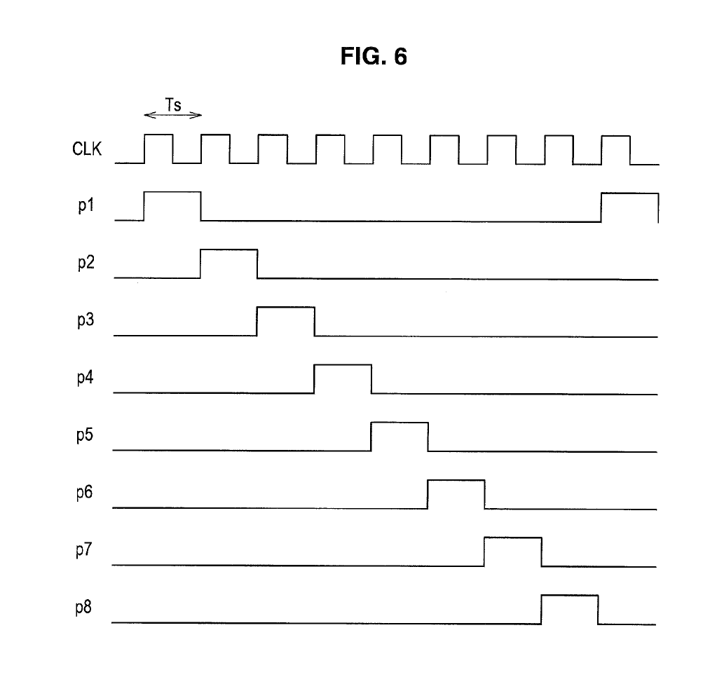

FIG. 5 is an explanatory view illustrating a discrete time charge domain filter 60 described in Non-Patent Literature 1. FIG. 6 is an explanatory view illustrating the waveforms of pulses to be applied to the discrete time charge domain filter 60.

The discrete time charge domain filter 60 illustrated in FIG. 5 includes a transconductance amplifier Gm, history capacitors Ch1 to Ch7, rotation capacitors Cr1 to Cr8, and switches Snm (1≦n≦8, 1≦m≦8). p1 to p8 attached to the vicinity of the switches Snm indicate that each of pulses p1 to p8 illustrated in FIG. 6 is applied to the corresponding switch.

The transconductance amplifier Gm is transconductance amplifier from the input terminal Vin to the discrete time charge domain filter 60 to the history capacitor Ch1.

The history capacitors Ch1 to Ch7 each are capacitors which accumulate or emit charges at a predetermined timing. The timing at which the history capacitors Ch1 to Ch7 accumulate or emit charges is determined by the ON/OFF timing of the switches Snm. The rotation capacitors Cr1 to Cr8 each are capacitors which receive and accumulate charges accumulated in the history capacitors Ch1 to Ch7 or supply the accumulated charges to the history capacitors Ch1 to Ch7 at a predetermined timing.

The discrete time charge domain filter 60 illustrated in FIG. 5 is configured so that the charges accumulated in the history capacitor Ch7 are output from the output Vout. V1 to V6 in the discrete time charge domain filter 60 illustrated in FIG. 5 denote first to 6th output voltages, respectively.

The operation of the discrete time charge domain filter 60 illustrated in FIG. 5 is described. When only the pulse p1 becomes high, switches S11, S21, . . . S81 enter the ON state. Then, the charges are distributed to the rotation capacitor Cr1 and the history capacitor Ch1, to the rotation capacitor Cr3 and the history capacitor Ch7, to the rotation capacitor Cr4 and the history capacitor Ch6, to the rotation capacitor Cr5 and the history capacitor Ch5, to the rotation capacitor Cr6 and the history capacitor Ch4, to the rotation capacitor Cr7 and the history capacitor Ch3, and to the rotation capacitor Cr8 and the history capacitor Ch2 in a corresponding manner. Since the rotation capacitor Cr2 is grounded, the charges currently accumulated in the rotation capacitor Cr2 are discharged.

Then, when only the pulse p2 becomes high, the switches S12, S22, . . . S82 enter the ON state. Then, the charges are distributed to the rotation capacitor Cr1 and the history capacitor Ch2, to the rotation capacitor Cr2 and the history capacitor Ch1, to the rotation capacitor Cr4 and the history capacitor Ch7, to the rotation capacitor Cr5 and the history capacitor Ch6, to the rotation capacitor Cr6 and the history capacitor Ch5, to the rotation capacitor Cr7 and the history capacitor Ch4, and to the rotation capacitor Cr8 and the history capacitor Ch3 in a corresponding manner. Since the rotation capacitor Cr3 is grounded, the charges accumulated in the rotation capacitor Cr3 are discharged.

Henceforth, the ON state and the OFF state of the switches Snm are successively switched by the similar repetition of the high state and the low state of the pulses on and after the pulse p3 and the distribution and the discharge of the charges accumulated in each capacitor are repeated. By the repetition of the high state and the low state of the pulses p1 to p8 as described above, the distribution and the discharge of the charges are repeated. The discrete time charge domain filter 60 illustrated in FIG. 5 operates as a 7th-order IIR low pass filter due to the fact that the filter has the seven history capacitors Ch1 to Ch7.

The discrete time charge domain filter 60 illustrated in FIG. 5 is configured so that the history capacitors Ch1 to Ch7 have the same capacity and the rotation capacitors Cr1 to Cr8 have the same capacity.

The transfer function of the discrete time charge domain filter 60 illustrated in FIG. 5 is shown in Expression 2. In Expression 2, Gm denotes the transconductance coefficient of the transconductance amplifier Gm, Ts denotes the period of the sampling clock, Cr denotes the capacity of the rotation capacitors Cr1 to Cr8, and Ch denotes the capacity of the history capacitors Ch1 to Ch7.

$$H ( z ) = \frac{{{GmT}_{S} ( {C}_{r} {z}^{- 1} )}^{6}}{{( {C}_{h} ( 1 - {z}^{- 1} ) + {C}_{r} )}^{7}} \qquad ( Expression 2 )$$

It is found from the discrete time charge domain filter 51 illustrated in FIG. 4 and the discrete time charge domain filter 60 illustrated in FIG. 5 that the circuit scale of the discrete time charge domain filter which does not employ an operational amplifier increases in proportion to the square of (n+1) in which 1 is added to the degree n. It is also found that the number of the switches used in the discrete time charge domain filter is given by (n+1)².

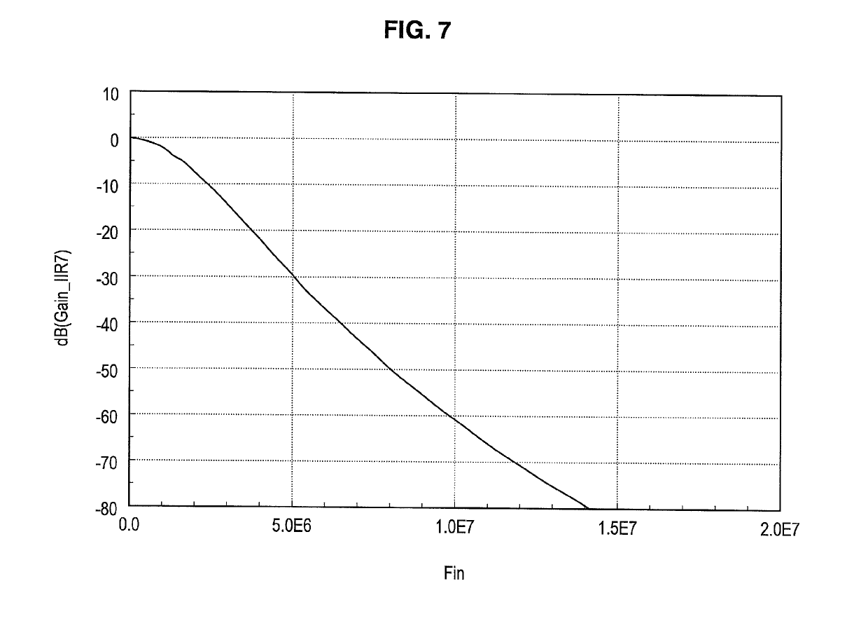

FIG. 7 is an explanatory view illustrating an example of the frequency characteristic of the discrete time charge domain filter 60 illustrated in FIG. 5. FIG. 7 shows the frequency characteristic when the discrete time charge domain filter 60 illustrated in FIG. 5 is configured so that the capacity Ch of the history capacitors Ch1 to Ch7 is 20 [pF], the capacity Cr of the rotation capacitors Cr1 to Cr8 is 0.5 [pF], the transconductance coefficient Gm of the transconductance amplifier Gm is 0.5 [mS], and the period Ts of the sampling clock is 1.0 [ns].

The discrete time charge domain filter 60 illustrated in FIG. 5 has a frequency characteristic as shown in FIG. 7. As shown in FIG. 7, the discrete time charge domain filter 60 has a gentle cutoff characteristic. Therefore, the discrete time charge domain filter 60 illustrated in FIG. 5 may not sufficiently attenuate interfering waves of adjacent frequencies and also attenuate a desired signal zone. When the degree is increased in order to increase the attenuation amount of the adjacent frequencies, the circuit scale increases in proportion to the square of (n+1) in which 1 is added to the degree n as described above. Therefore, with an increase in the number of switches and capacitors, the power consumption increases or the chip area increases.

Then, the following description describes a discrete time charge domain filter capable of attenuating interfering waves of adjacent frequencies without affecting the circuit scale and capable of suppressing attenuation of a desired zone.

### Example of Circuit Configuration

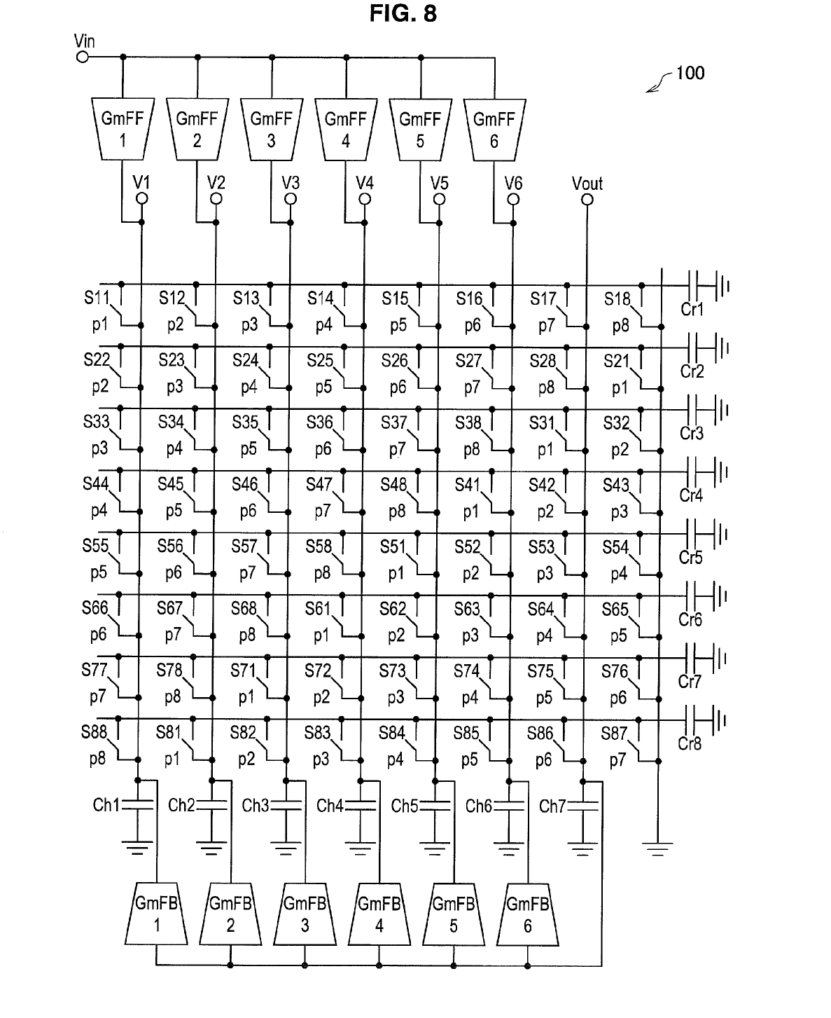

FIG. 8 is an explanatory view illustrating an example of the circuit configuration of a discrete time charge domain filter 100 according to one embodiment of the present disclosure. Hereinafter, an example of the circuit configuration of the discrete time charge domain filter 100 according to one embodiment of the present disclosure using FIG. 8 is described.

The discrete time charge domain filter 100 illustrated in FIG. 8 includes transconductance amplifiers GmFF1 to GmFF6 and GmFB1 to GmFB6, history capacitors Ch1 to Ch7, rotation capacitors Cr1 to Cr8, and switches Snm (1≦n≦8, 1≦m≦8). p1 to p8 attached to the vicinity of the switches Snm indicate that each of the pulses p1 to p8 illustrated in FIG. 6 is applied to the corresponding switch.

The transconductance amplifiers GmFF1 to GmFF6 are feedforward transconductance amplifiers from the input terminal Vin to the discrete time charge domain filter 100 to the history capacitors Ch1 to Ch 6.

The transconductance amplifiers GmFB1 to GmFB6 are feedback transconductance amplifiers from the output Vout from the discrete time charge domain filter 100 to the history capacitors Ch1 to Ch 6.

The history capacitors Ch1 to Ch7 each are an example of a first capacitor according to an embodiment of the present disclosure and capacitors which accumulate or emit charges at a predetermined timing. The timing at which the history capacitors Ch1 to Ch7 accumulate or emit charges is determined by the ON/OFF timing of the switches Snm. The rotation capacitors Cr1 to Cr8 each are an example of a second capacitor according to an embodiment of the present disclosure and capacitors which receive and accumulate charges accumulated in the history capacitors Ch1 to Ch7 or supply the accumulated charges to the history capacitors Ch1 to Ch7 at a predetermined timing.

The discrete time charge domain filter 100 illustrated in FIG. 8 is configured so that the charges accumulated in the history capacitor Ch7 are output from the output Vout. V1 to V6 in the discrete time charge domain filter 100 illustrated in FIG. 8 denote first to 6th output voltages, respectively.

In the discrete time charge domain filter 100 according to one embodiment of the present disclosure, the transconductance coefficient of each of the transconductance amplifiers GmFF1 to GmFF6 and GmFB1 to GmFB6 is programmable. For example, the transconductance coefficient of each of the transconductance amplifiers GmFF1 to GmFF6 and GmFB1 to GmFB6 may be set to any value of minus, zero, and plus.

With the transconductance amplifiers GmFB1 to GmFB6 illustrated in FIG. 8, a current proportional to the output voltage Vout flows from the discrete time charge domain filter 100 to the history capacitors Ch1 to Ch6. Therefore, charges are accumulated in the history capacitors Ch1 to Ch6 by the current from the transconductance amplifiers GmFF1 to GmFF6 and the current from the transconductance amplifiers GmFB1 to GmFB6.

The operation of the discrete time charge domain filter 100 illustrated in FIG. 8 is described. When only the pulse p1 becomes high, the switches S11, S21, . . . S81 enter the ON state. Then, the charges are distributed to the rotation capacitor Cr1 and the history capacitor Ch1, to the rotation capacitor Cr3 and the history capacitor Ch7, to the rotation capacitor Cr4 and the history capacitor Ch6, to the rotation capacitor Cr5 and the history capacitor Ch5, to the rotation capacitor Cr6 and the history capacitor Ch4, to the rotation capacitor Cr7 and the history capacitor Ch3, and to the rotation capacitor Cr8 and the history capacitor Ch2 in a corresponding manner. Since the rotation capacitor Cr2 is grounded, the charges accumulated in the rotation capacitor Cr2 are discharged.

Then, when only the pulse p2 becomes high, the switches S12, S22, . . . S82 enter the ON state. Then, the charges are distributed to the rotation capacitor Cr1 and the history capacitor Ch2, to the rotation capacitor Cr2 and the history capacitor Ch1, to the rotation capacitor Cr4 and the history capacitor Ch7, to the rotation capacitor Cr5 and the history capacitor Ch6, to the rotation capacitor Cr6 and the history capacitor Ch5, to the rotation capacitor Cr7 and the history capacitor Ch4, and to the rotation capacitor Cr8 and the history capacitor Ch3 in a corresponding manner. Since the rotation capacitor Cr3 is grounded, the charges accumulated in the rotation capacitor Cr3 are discharged.

Henceforth, the ON state and the OFF state of the switches Snm are successively switched by the similar repetition of the high state and the low state of the pulses on and after the pulse p3 and the distribution and the discharge of the charges accumulated in each capacitor are repeated. The charges accumulated in the rotation capacitors Cr1 . . . Cr8 are discharged when the switches S18 . . . S87 enter the ON state, in a corresponding manner.

Thus, by the repetition of the high state and the low state of the pulses p1 to p8 as described above, the distribution and the discharge of the charges are repeated. The discrete time charge domain filter 100 illustrated in FIG. 8 operates as a 7th-order IIR low pass filter due to the fact that the filter has the seven history capacitors Ch1 to Ch7.

The discrete time charge domain filter 100 illustrated in FIG. 8 is configured so that the history capacitors Ch1 to Ch7 have the same capacity and the rotation capacitors Cr1 to Cr8 have the same capacity.

The transfer function of the discrete time charge domain filter 100 according to one embodiment of the present disclosure illustrated in FIG. 8 is shown in Expression 3. In Expression 3, n is a degree. In the discrete time charge domain filter 100 according to one embodiment of the present disclosure illustrated in FIG. 8, the degree n is 7.

$$H ( z ) = \frac{{T}_{S} \cdot {\sum }_{k = 1}^{n - 1} [ {GmFF}_{k} {\{ \frac{{C}_{r} {z}^{- 1}}{{C}_{h} ( 1 - {z}^{- 1} ) + {C}_{r}} \}}^{n - k} ]}{\begin{matrix}\{ {C}_{h} ( 1 - {z}^{- 1} ) + {C}_{r} \} - {T}_{S} \cdot \\ {\sum }_{k = 1}^{n - 1} [ {GmFB}_{k} {\{ \frac{{C}_{r} {z}^{- 1}}{{C}_{h} ( 1 - {z}^{- 1} ) + {C}_{r}} \}}^{n - k} ]\end{matrix}} \qquad ( Expression 3 )$$

An example of the frequency characteristic of the discrete time charge domain filter 100 is described. First, an example of the frequency characteristic when the capacity Ch of the history capacitors Ch1 to Ch7 is 20 [pF], the capacity Cr of the rotation capacitors Cr1 to Cr8 is 0.5 [pF], the period Ts of the sampling clock is 1.0 [ns], and the transconductance coefficient of each of the transconductance amplifiers GmFF1 to GmFF6 and GmFB1 to GmFB6 is set as shown in the following table 1 is described.

TABLE 1
(Setting example of transconductance coefficient)

| Gm name | Value | Unit | Gm name | Value | Unit |
|---|---|---|---|---|---|
| GmFF1 | 0.5 | mS | GmFB1 | 0 | mS |
| GmFF2 | 0 | mS | GmFB2 | 0 | mS |
| GmFF3 | 0 | mS | GmFB3 | −0.125 | mS |
| GmFF4 | 0 | mS | GmFB4 | −0.125 | mS |
| GmFF5 | 0 | mS | GmFB5 | 0 | mS |
| GmFF6 | 0 | mS | GmFB6 | 0.25 | mS |

In Table 1 above, the transconductance coefficient of each of the transconductance amplifiers GmFB3 and GmFB4 is set to minus values. More specifically, in the transconductance amplifiers GmFB3 and GmFB4, a current flows in the opposite direction (flows toward the output Vout).

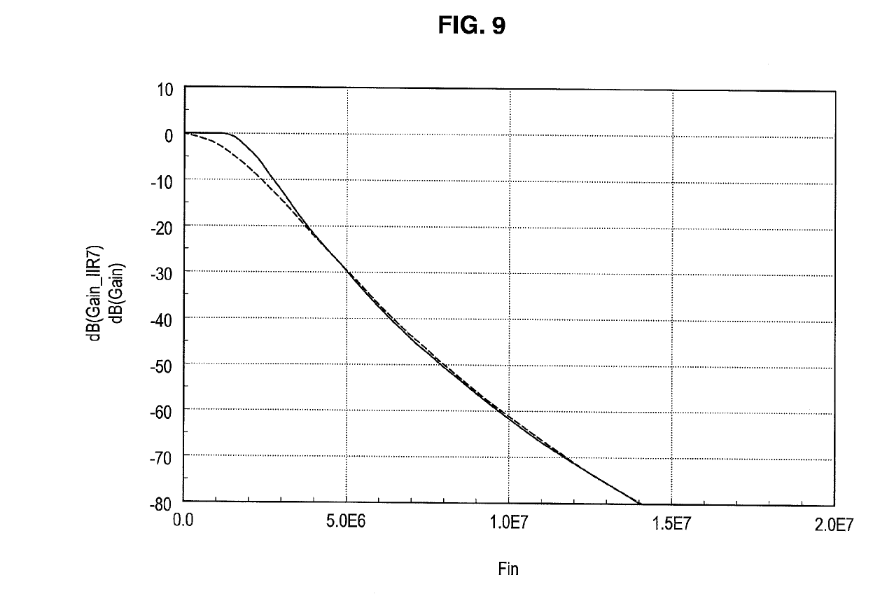

FIG. 9 is an explanatory view showing the frequency characteristic of the discrete time charge domain filter 100 in a graph when the circuit constants are set as described above. In the graph shown in FIG. 9, the solid line represents the frequency characteristic when the circuit constants are set as shown in Table 1 and the dashed line represents the frequency characteristic shown in FIG. 7.

When the circuit constants are set as described above, with respect to the frequency characteristic of the discrete time charge domain filter 100, the frequency characteristic around the cutoff frequency flatly rises and the −3-dB bandwidth extends to 1.9 MHz from 1.25 MHz as compared with the frequency characteristic shown in FIG. 7.

As shown in Table 1, the total transconductance coefficient of the transconductance amplifiers GmFF1 to GmFF6 and GmFB1 to GmFB6 is 0.5 [mS]. This value is the same as the value of the transconductance coefficient Gm of the transconductance amplifier Gm of the discrete time charge domain filter 60 illustrated in FIG. 5 By setting the total transconductance coefficient of the transconductance amplifiers GmFF1 to GmFF6 and GmFB1 to GmFB6 to be the same as that of the transconductance coefficient Gm of the transconductance amplifier Gm of the discrete time charge domain filter 60, the same DC gain as that of the discrete time charge domain filter 60 can be obtained.

In other words, the DC gain of the discrete time charge domain filter 100 is determined by the total transconductance coefficient of the transconductance amplifiers GmFF1 to GmFF6 and GmFB1 to GmFB6.

Moreover, as shown in Table 1, the total transconductance coefficient of the transconductance amplifiers GmFB1 to GmFB6 toward the history capacitors Ch1 to Ch6, respectively, from the output Vout of the discrete time charge domain filter 100 is set to be zero. By setting the total transconductance coefficient of the transconductance amplifiers GmFB1 to GmFB6 to be zero as described above, the DC gain of the discrete time charge domain filter 100 is set to be the same as that of the discrete time charge domain filter 60.

Another example of the frequency characteristic of the discrete time charge domain filter 100 is described. First, an example of the frequency characteristic when the capacity Ch of the history capacitors Ch1 to Ch7 is 20 [pF], the capacity Cr of the rotation capacitors Cr1 to Cr8 is 0.5 [pF], the period Ts of the sampling clock is 1.0 [ns], and the transconductance coefficient of each of the transconductance amplifiers GmFF1 to GmFF6 and GmFB1 to GmFB6 further is set as shown in the following table 2 is described.

TABLE 2
(Setting example of transconductance coefficient)

| Gm name | Value | Unit | Gm name | Value | Unit |
|---|---|---|---|---|---|
| GmFF1 | 0.5 | mS | GmFB1 | 0 | mS |
| GmFF2 | 0 | mS | GmFB2 | 0 | mS |
| GmFF3 | 0 | mS | GmFB3 | −0.125 | mS |
| GmFF4 | 0.07 | mS | GmFB4 | −0.125 | mS |
| GmFF5 | 0 | mS | GmFB5 | 0 | mS |
| GmFF6 | 0 | mS | GmFB6 | 0.18 | mS |

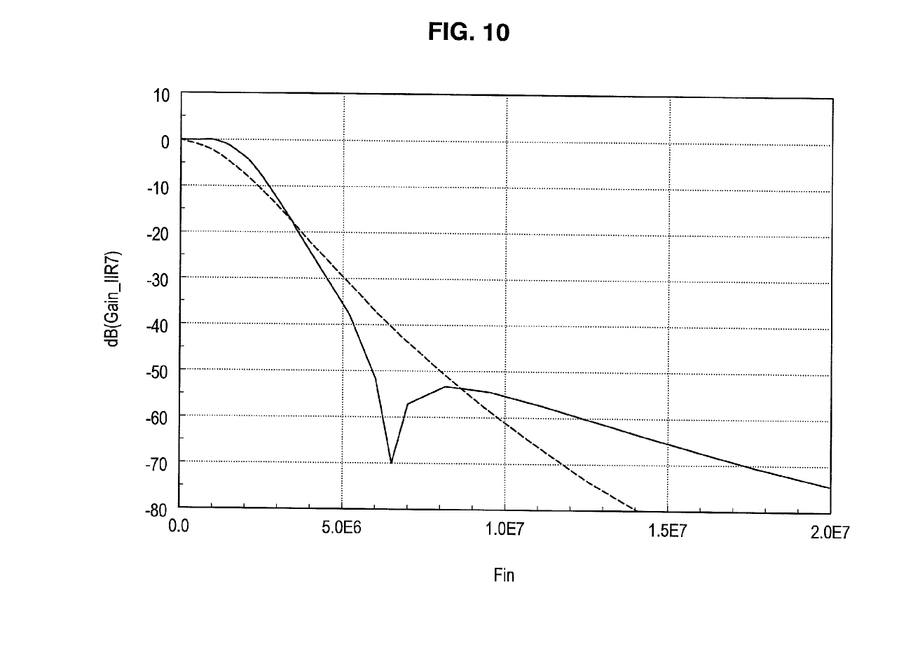

FIG. 10 is an explanatory view showing the frequency characteristic of the discrete time charge domain filter 100 in a graph when the circuit constants are set as described above. In the graph shown in FIG. 10, the solid line represents the frequency characteristic and the dashed line represents the frequency characteristic shown in FIG. 7 when the circuit constants are set as shown in Table 2.

As shown in Table 2, the total transconductance coefficient of the transconductance amplifiers GmFF1 to GmFF6 and GmFB1 to GmFB6 is 0.5 [mS]. This value is the same as the value of the transconductance coefficient Gm of the transconductance amplifier Gm of the discrete time charge domain filter 60 illustrated in FIG. 5 By setting the total transconductance coefficient of the transconductance amplifiers GmFF1 to GmFF6 and GmFB1 to GmFB6 to be the same as that of the transconductance coefficient Gm of the transconductance amplifier Gm of the discrete time charge domain filter 60, the same DC gain as that of the discrete time charge domain filter 60 can be obtained.

When the circuit constants are set as shown in Table 2, with respect to the frequency characteristic of the discrete time charge domain filter 100, the frequency characteristic around the cutoff frequency flatly rises and the −3-dB bandwidth extends to 1.9 MHz from 1.25 MHz as compared with the frequency characteristic shown in FIG. 7. When the circuit constants are set as described above, with respect to the frequency characteristic of the discrete time charge domain filter 100, the attenuation pole can be set around 6.5 MHz, and therefore the attenuation amount of a nearby frequency is increased.

The ratio of GmFF4 to GmFF1 to be set in order to produce the attenuation pole is a value determined based on the ratio N of the capacity Ch of the history capacitor to the capacity Cr of the rotation capacitor as shown in the following expression 4. The ratio of GmFF4 to GmFF1 shown in Expression 4 is equivalent to the conditions in which the numerator is 0 when values are given to GmFF4 and GmFF1 in Expression 3.

$$\frac{GmFF 4}{GmFF 1} = - {[ \frac{X - j \sqrt{1 - {X}^{2}}}{N \{ 1 - ( X - j \sqrt{1 - {X}^{2}} ) \} + 1} ]}^{3} \qquad ( Expression 4 )$$

X in Expression 4 is determined by the following expression 5.

$$X = \frac{3 N + \sqrt{{N}^{2} + 8 N + 4}}{4 ( N + 1 )} , \\ N = \frac{{C}_{h}}{{C}_{r}} \qquad ( Expression 5 )$$

When N=40 is substituted into Expression 5, the ratio of GmFF4 to GmFF1 in Expression 4 is 0.139. Therefore, when GmFF1 is set to 0.5 [mS], GmFF4 is 0.07 [mS].

As is understood from Expression 4 and Expression 5, the ratio of GmFF4 to GmFF1 is determined based on the ratio N of the capacity Ch of the history capacitors Ch1 to Ch7 to the capacity Cr of the rotation capacitors Cr1 to Cr8. Therefore, this ratio has a feature in that the ratio is hard to change to the variation in the CMOS process.

In order to set the DC gain of the discrete time charge domain filter 100 to be the same as that of the discrete time charge domain filter 60 having the configuration illustrated in FIG. 5, the total transconductance coefficient which increased due to the fact that the transconductance coefficient is set to GmFF4 as shown in Table 2 is adjusted by reducing the GmFB6 value. Thus, the DC gain of the discrete time charge domain filter 100 is determined based on the total transconductance coefficient of the transconductance amplifiers GmFF1 to GmFF6 and GmFB1 to GmFB6.

In the frequency characteristic shown in FIG. 10, the frequency f_{notch} at which the attenuation pole is produced is determined based on the ratio N of the capacity Ch of the history capacitors Ch1 to Ch7 to the capacity Cr of the rotation capacitors Cr1 to Cr8 and the period Ts of the sampling clock CLK as shown in the following expression 6. Therefore, the frequency at which the attenuation pole is produced has a feature in that the frequency is hard to change to the variation in the CMOS process.

$${f}_{notch} = \frac{a cos [ X ]}{2 π {T}_{S}} \qquad ( Expression 6 )$$

When N=40 and Ts=1.0 [ns] are substituted into Expression 5 and Expression 6, respectively, the frequency at which the attenuation pole is produced is f_{notch}=6.496 [MHz].

In the frequency characteristic shown in FIG. 10, the frequency f_{notch} at which the attenuation pole is produced may change based on a value to be given to the transconductance amplifiers GmFF1 to GmFF6. For example, in an example of the circuit configuration of the discrete time charge domain filter 100 illustrated in FIG. 8, when values are given to the transconductance amplifiers GmFF2 and GmFF3 on the side (side where charges faster move to the rotation capacitor in terms of time) near the transconductance amplifier GmFF1, the attenuation pole can be produced at a higher frequency.

On the other hand, in an example of the circuit configuration of the discrete time charge domain filter 100 illustrated in FIG. 8, when values are set to the transconductance amplifiers GmFF5 and GmFF6 on the side (side where charges more slowly move to the rotation capacitor in terms of time) distant from the transconductance amplifier GmFF1, the attenuation pole can be produced at a lower frequency.

The discrete time charge domain filter 100 illustrated in FIG. 8 can sufficiently attenuate interfering waves of adjacent frequencies and suppress the attenuation of a desired signal zone without affecting the circuit scale by setting the transconductance coefficient of each of the transconductance amplifiers GmFF1 to GmFF6 and GmFB1 to GmFB6 to an appropriate value. Therefore, the discrete time charge domain filter 100 illustrated in FIG. 8 is an IIR filter suitably applied to the LPFs 25a and 25b of the wireless communication terminal 10 illustrated in FIG. 1.

By the use of the discrete time charge domain filter 100 for the LPFs 25a and 25b, the LNA 23, the mixers 24a and 24b, the LPFs 25a and 25b, and the A/D converters 26a and 26b constitute an example of an integrated circuit according to an embodiment of the present disclosure, and further one obtained by adding the duplexer 22 to the integrated circuit constitutes an example of a communication module according to an embodiment of the present disclosure. One obtained by adding the antenna 11 to the communication module constitutes an example of a communication apparatus according to an embodiment of the present disclosure.

### 2. CONCLUSION

According to one embodiment of the present disclosure, the discrete time charge domain filter 100 provided with the feedforward transconductance amplifiers GmFF1 to GmFF6 and the feedback transconductance amplifiers GmFB1 to GmFB6 is provided.

By setting the transconductance coefficient of each of the transconductance amplifiers GmFF1 to GmFF6 and GmFB1 to GmFB6 to an appropriate value, the discrete time charge domain filter 100 according to one embodiment of the present disclosure can achieve a steep cutoff characteristic and the extension of the −3-dB bandwidth. Moreover, the discrete time charge domain filter 100 according to one embodiment of the present disclosure can set the attenuation pole and increase the attenuation amount of the nearby frequency.

More specifically, the discrete time charge domain filter 100 according to one embodiment of the present disclosure can sufficiently attenuate interfering waves of adjacent frequencies and also can suppress the attenuation of the a desired signal zone without affecting the circuit scale.

The description above describes an example in which the discrete time charge domain filter 100 is applied to the LPFs 25a and 25b but the present disclosure is not limited to the example. The discrete time charge domain filter 100 may also be applied to a filter contained in the transmission module 41.

Moreover, the description above describes an embodiment in which the discrete time charge domain filter 100 has a single phase configuration but the present disclosure is not limited to the example. The discrete time charge domain filter 100 may have a differential configuration. Due to the fact that the discrete time charge domain filter 100 has a differential configuration, the change of the polarity is facilitated.

Moreover, the description above describes that the capacity value of each of the history capacitors Ch1 to Ch6 and the rotation capacitors Cr1 to Cr7 contained in the discrete time charge domain filter 100 is a fixed value but the present disclosure is not limited to the example. The capacity value of each of the history capacitors Ch1 to Ch6 and the rotation capacitors Cr1 to Cr7 may be variable. By changing the capacity value due to the fact that the capacity value of each of the history capacitors Ch1 to Ch6 and the rotation capacitors Cr1 to Cr7 is variable, the frequency characteristic can be changed.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A filter circuit, including:

one or more first capacitors which accumulate and emit a charge at a predetermined timing;

one or more first amplifiers which are provided from an input terminal side to the one or more first capacitors and output a current proportional to an input voltage into the input terminal; and

one or more second amplifiers which are provided from an output terminal side to the one or more first capacitors and output a current proportional to an output voltage from the output terminal,

wherein a proportionality coefficient of each of the one or more first amplifiers and each of the one or more second amplifiers is arbitrarily set.

(2) The filter circuit according to (1), wherein the proportionality coefficient of each of the one or more first amplifiers and each of the one or more second amplifiers is set to minus, zero, or plus.
(3) The filter circuit according to (1) or (2), wherein a total of the proportionality coefficient of each of the one or more first amplifiers and the proportionality coefficient of each of the one or more second amplifiers is fixed.
(4) The filter circuit according to any one of (1) to (3), further including:

one or more second capacitors which are provided corresponding to the one or more first capacitors and accumulate and emit a charge at a predetermined timing,

wherein a ratio of the proportionality coefficient of each of the one or more first amplifiers is determined based on a capacity ratio of the one or more first capacitors to the one or more the second capacitors.

(5) An integrated circuit, including:

the filter circuit according to any one of (1) to (4).

(6) A communication module, including:

the integrated circuit according to (5); and

a duplexer.

(7) A communication apparatus, including:

the communication module according to (6); and

an antenna which transmits and receives a radio wave and exchanges the radio wave with the communication module.

What is claimed is:

1. A filter circuit, comprising:
one or more first capacitors which accumulate and emit a charge at a predetermined timing;
one or more first amplifiers which are provided from an input terminal side to the one or more first capacitors and output a current proportional to an input voltage into the input terminal; and
one or more second amplifiers which are provided from an output terminal side to the one or more first capacitors and output a current proportional to an output voltage from the output terminal,
wherein a proportionality coefficient of each of the one or more first amplifiers and each of the one or more second amplifiers is arbitrarily set.

2. The filter circuit according to claim 1, wherein the proportionality coefficient of each of the one or more first amplifiers and each of the one or more second amplifiers is set to minus, zero, or plus.

3. The filter circuit according to claim 1, wherein a total of the proportionality coefficient of each of the one or more first amplifiers and the proportionality coefficient of each of the one or more second amplifiers is fixed.

4. The filter circuit according to claim 1, further comprising:
one or more second capacitors which are provided corresponding to the one or more first capacitors and accumulate and emit a charge at a predetermined timing,
wherein a ratio of the proportionality coefficient of each of the one or more first amplifiers is determined based on a capacity ratio of the one or more first capacitors to the one or more the second capacitors.

5. An integrated circuit, comprising:
the filter circuit according to claim 1.

6. A communication module, comprising:
the integrated circuit according to claim 5; and
a duplexer.

7. A communication apparatus, comprising:
the communication module according to claim 6; and
an antenna which transmits and receives a radio wave and exchanges the radio wave with the communication module.
